(19) United States
(12) Patent Application Publication
(10) Pub. No.: US 2010/0124587 A1
(43) Pub. Date: May 20, 2010

(54) Creatine-containing vitamin and mineral composition

(76) Inventors: Marvin A. Heuer, (US); Erin Taraborrelli, (US); Ken Clement, (US); Megan Thomas, (US); Philip Apong, (US)

Correspondence Address: IOVATE HEALTH SCIENCE RESEARCH INC., 381 North Service Road West, Oakville, ON, L6M 0H4, CA

(21) Appl. No.: 12/313,050

(22) Filed: Nov. 17, 2008

(51) Int. Cl. A23L 1/303; A23L 1/30

(52) U.S. Cl. 426/73; 426/72

(57) ABSTRACT

A composition and method is provided for supporting multiple aspects of mammalian energy producing systems. Creatine, a key substance for energy production, is provided along with a substance to enhance the uptake of creatine and vitamins and minerals involved in energy metabolism. The compositions may further comprise additional components with anabolic and antioxidant activity. The compositions are suitable for supplementing the diet of individuals engaging in physical activity, particularly intense physical activity.

### FIELD OF THE INVENTION

The invention related generally to compositions and methods for supporting various energy pathways in individuals. More specifically, the invention provides compositions and methods to support both aerobic and anaerobic energy systems in individuals to maintain physical performance during both short duration high intensity activities and long duration lower intensity endurance activities.

### BACKGROUND OF THE INVENTION

Nutrients such as carbohydrate, fat, and protein are converted by the body to energy in the form of adenosine triphosphate (ATP). This energy from consumed nutrients contributes to the fuel supply needed by the body to perform exercise. The breakdown of ATP allows muscles to contract.

Since ATP is a relatively short-lived species, it must be constantly replenished, particularly during physical activity. There are two main pathways by which ATP can be regenerated: aerobic metabolism and anaerobic metabolism.

The anaerobic system supports relatively short duration, high intensity activity. ATP in muscle only supports about 2 to 3 seconds of activity. Creatine, with a bound phosphate in the form of phosphocreatine, is used biochemically by muscle to regenerate ATP and has a capacity for supporting high intensity energy requirements for about an additional 8 seconds.

Once ATP and phosphocreatine are depleted, or the rate at which they are required exceeds the rate of regeneration, an alternative energy source is required. Anaerobic glycolysis produces ATP solely from carbohydrates and may supply energy for several minutes of high intensity, intermittent activity.

Long duration endurance activity, typically at a lower intensity, is fueled by aerobic metabolism which uses carbohydrates, fats and proteins, to produce ATP. Aerobic energy production operates at a slower rate and depends on the circulatory system for transporting oxygen to muscle requiring energy.

During physical activity, the portion of each energy system used will depend on a number of factors including the duration and degree of intensity and the availability of substrates such as carbohydrates, fats, proteins and oxygen. Vitamin and mineral supplementation is important to ensure good health and to help ensure energy requirements are met, particularly when an individual is lacking sources from diet. The athlete has many nutritional requirements, which can easily become depleted during training and performance. When one or more of the trace elements are missing, its role in metabolism and energy utilization becomes impaired, and thus performance decreases.

### SUMMARY OF THE INVENTION

It is an object of the present invention to provide new dietary supplements. It is a more specific object of the present invention to support cellular energetics. A further object of the present invention is to support both aerobic and anaerobic energy systems in individuals engaging in intense physical activity. Accordingly, compositions are disclosed comprising creatine or derivatives of creatine, at least one insulin support substance and a vitamin-mineral mix.

Thus, in certain embodiments, the present invention provides compositions comprising creatine or derivatives of creatine, at least one insulin support substance and a vitamin-mineral mix. The insulin support substance may be selected from the group consisting of alpha-lipoic acid, ketoisocaproate, D-pinitol, Protogen A, taurine, and respective derivatives thereof.

In other embodiments, from about 1% by weight to about 10% by weight of the creatine or derivatives of creatine and the vitamin-mineral mix is fine-milled.

In other embodiments, the vitamin-mineral mix comprises at least one dietary vitamin and at least one dietary mineral. The dietary vitamin may be selected from the group consisting of: Vitamin A, Vitamin C, Vitamin D, Vitamin E, Vitamin K, Vitamin K2, Vitamin B1, Vitamin B2, Vitamin B3, Vitamin B5, Vitamin B6, Vitamin B7, Vitamin B9, Vitamin B12, and respective derivatives thereof; and the dietary mineral may be selected from the group consisting of: calcium, iron, iodine, magnesium, selenium, zinc, copper, manganese, chromium, sodium, potassium, gold, silver, and respective derivatives thereof.

In other embodiments, the compositions of the present invention may further comprise one or more anabolic substances. The anabolic substances may comprise an anabolic substance selected from the group consisting of: choline, leucine, valine, isoleucine, lysine, threonine, carnitine, respective derivatives thereof, and an extract of Agaricus bisporus.

In other embodiments, the compositions of the present invention may further comprise one or more antioxidant substances. The antioxidant substance may comprise an antioxidant substance selected from the group consisting of: Vitamin A, Vitamin C, Vitamin E, selenium, alpha-lipoic acid, astaxanthin, coenzyme Q9, coenzyme Q10, lutein, N-acetyl cysteine, superoxide dismutase, idebenone, Polygonum cuspidatum; tomato extract, Ginkgo biloba, grape extract, ginger extract, apple extract, mulberry extract, blueberry extract, bilberry extract, blackberry extract, and acai berry extract. Provided, the antioxidant substance is different than the components of the vitamin-mineral mix and the insulin support substance.

In certain embodiments, the present invention comprises a composition comprising: creatine, Leucine, alpha-lipoic acid, Vitamin C, Vitamin B3, and magnesium.

In certain embodiments, the present invention provides methods of supporting cellular energetics in an individual, the method comprising providing to said individual a composition as described herein. In certain embodiments, said composition comprises creatine and/or derivatives of creatine, at least one insulin support substance and a vitamin-mineral mix.

### DETAILED DESCRIPTION OF THE INVENTION

In the following description, for the purposes of explanation, numerous specific details are set forth in order to provide a thorough understanding of the present invention. It will be apparent, however, to one skilled in the art that the present invention may be practiced without these specific details.

The present invention relates to supporting cellular energetics by supplying creatine along with substances acting to increase creatine uptake and retention. Vitamins and minerals are also supplied to support cellular energetics. The individual components of the present invention act upon distinct facets of cellular energetics.

### Definitions

A used herein, the term ‘nutritional composition’ includes dietary supplements, diet supplements, nutritional supplements, supplemental compositions and supplemental dietary compositions or those similarly envisioned and termed compositions not belonging to the conventional definition of pharmaceutical interventions as is known in the art. Furthermore, ‘nutritional compositions’ as disclosed herein belong to category of compositions having at least one physiological function when administered to a mammal by conventional routes of administration.

Alternatively, formulations and nutritional compositions belonging to the present invention may be considered to be nutraceuticals. As used herein, the term ‘nutraceutical’ is recognized and used in the art to describe a specific chemical compound or combination of compounds found in, organic matter for example, which may prevent, ameliorate or otherwise confer benefits against an undesirable condition. As is known in the art, the term ‘nutraceutical’ is used to refer any substance that is a food, a part of food, or an extract of food which is suitable for consumption by an individual and providing physiological benefit which may be medical or health-related. Furthermore, the term has been used to refer to a product isolated, extracted or purified from foods or naturally-derived material suitable for consumption by an individual and usually sold in medicinal forms, such as caplets, tablet, capsules, soft-gel™ caplets, gel-caps and the like, not associated with food.

As used herein, the term ‘cellular energetics’ refers to all pathways for producing energy in mammalian cells—both aerobic and anaerobic. Likewise, as used herein, the term “support cellular energetics” refers to any means of promoting or enhancing cellular energetics. Means of supporting cellular energetics may include, but are not limited to: supplying substrates for energy production, supplying enzymes or cofactors for metabolism, and supplying factors for protecting cell membranes and metabolic enzymes from degradation, reactive oxygen species or other free radicals.

As used herein, the term “vitamin-mineral mix” refers to a combination of at least one known vitamin with at least one known mineral. The term “vitamin-mineral mix” also includes combinations of multiple vitamins with multiple minerals. A combination of all commonly known vitamins and minerals, as would be understood by one of skill in the art, would likewise be a “vitamin-mineral mix” according to the present invention.

As used herein, the term “insulin support” refers to any mechanism by which the biological action of insulin is increased, enhanced or in any way made more efficient. These mechanisms include, but are not limited to: increasing insulin synthesis, increasing insulin secretion, increasing insulin receptor synthesis, increasing the binding of insulin to insulin receptors, and decreasing any mechanism acting to inhibit the biological activity of insulin. Likewise, an “insulin support substance”, as used herein, refers to any substance that promotes the biological action of insulin.

As used herein, the term “anabolic” refers the condition of net muscle, or muscle cell protein, increase. It is herein understood that muscle catabolism (breakdown, decrease) and muscle anabolism (buildup, increase) are processes that may occur continually and simultaneously and that the net phenotypic effect on skeletal muscle depends on the relative contribution of each. “Anabolic substance” as used herein refers to any substance which contributes to the promotion of an anabolic state.

As used herein, ‘creatine’ refers to the chemical N-methyl-N-guanyl Glycine, (CAS Registry No. 57-00-1), also known as, (alpha-methyl guanido) acetic acid, N-(aminoiminomethyl)-N-glycine, Methylglycocyamine, Methylguanidoacetic Acid, or N-Methyl-N-guanylglycine. Additionally, as used herein, ‘creatine’ also includes derivatives of creatine such as esters and salts. Creatine is a naturally occurring amino acid derived from the amino acids glycine, arginine, and methionine. Although it is found in meat and fish, it is also synthesized by humans. Creatine is predominantly used as a fuel source in muscle. About 65% of creatine is stored in muscle as phosphocreatine (creatine bound to a phosphate molecule). Preferably, a serving of the composition comprises from about 1 g to about 5 9 of creatine or a derivative of creatine.

Carbohydrate ingestion is known to stimulate the secretion of insulin which in turn facilitates the uptake of glucose into skeletal muscle. Furthermore, insulin promotes the uptake of amino acids into muscle and stimulates protein synthesis. Insulin has also been shown to stimulate creatine uptake by muscle cells.

Other substances have been shown to improve creatine retention or act as an insulin support substance. Non-limiting examples of such substances are alpha-lipoic acid, ketoisocaproate, D-pinitol, Protogen A, and taurine. It is herein understood that substances that a substance that has insulin support activity will act to increase the uptake and/or retention of creatine by muscle cells. The preferred insulin support substances of the present invention are alpha-lipoic acid and ketoisocaproate . . . .

As used herein, the term “derivative” refers to a compound, such as a salt, ester, or amine, which can readily supply a closely related biologically active compound, either upon administration or upon exposure to specific environment al conditions, such as pH, temperature, etc. For example, a “derivative” of creatine can be a salt, ester or amine of creatine, so long as the derivative can readily supply biologically active creatine. For a given compound, the, skilled person in the art will readily recognize and envisage those closely related compounds which should be considered “derivatives.”

Thus, for example, a derivative of a particular substance may comprise a form of that substance which has been modified through reaction. Other derivatives are forms of a given substance that are precursors of that substance which would give rise to that substance after modification. Reactions involved in the formation of derivatives include, but are not limited to: hydroxylation, esterification, amide formation and salt formation.

Most vitamins are involved in important biological processes. For example, most B-vitamins are involved in metabolic processing of carbohydrates and fats for energy production. Other B-vitamins are involved in the production of hemoglobin used for the transport of oxygen used in aerobic metabolism. Certain vitamin deficiencies are known to impair physical performance. Also, dosages of many vitamins beyond the Recommended Daily Allowance (RDA) have been shown to be beneficial for individuals involved in intense physical activity. Table 1 lists common vitamins and their roles.

TABLE 1
Common Vitamins

| | |
|---|---|
| Vitamin A | Required for differentiation of epithelium and plays a putative role in |
| (Beta-carotene) | proteoglycan synthesis. |
| | Required for normal vision, gene expression, growth and immune |
| | function. |
| | Deficiency leads to poor wound healing and keratinization of epithelial |
| | tissue. |
| | Deficiency leads to decreased epithelial cell differentiation, appetite |
| | loss, and prone to infections. |
| Vitamin C | Potent antioxidant that serves to regenerate vitamin E from it's |
| (Ascorbate) | oxidized by product. |
| | Deficiency leads to poor wound healing, decreased collagen |
| | synthesis, impaired bone development, and loss of basement |
| | membrane integrity. |
| Vitamin D | Required for bone collagen synthesis and osteoblast differentiation |
| (Cholecalciferol) | (promotes calcium absorption and use in bone formation). |
| | Deficiency leads to poor bone growth and development; with an |
| | excess, decreased collagen synthesis. |
| Vitamin E | Serves as an antioxidant of polyunsaturated fatty acid in cell |
| (Tocopherol) | membranes and sub cellular structures. |
| | Influences cellular response to oxidative stress through signal |
| | transduction pathways. |
| | May play a differential role in oxidative metabolism of different muscle |
| | fibers (higher vitamin E content in type I muscle fibers). |
| | Deficiency leads to altered wound healing, nerve and muscle damage. |
| | Deficiency increases oxidative stress in skeletal muscles, alters |
| | muscle fiber types and causes degradation and inflammatory |
| | processes that lead to dystrophic conditions. |
| Vitamin K | Cofactor in gamma-carboxylations of glutamyl residues in osteocalcin |
| (Phytonadione) | and coagulation. |
| | Deficiency leads to altered bone mineralization. |
| Vitamin B1 | Required for carbohydrate and amino acid metabolism. |
| (Thiamine) | Required for collagen synthesis. |
| | Deficiency leads to weakness, decreased endurance, muscle wasting, |
| | and weight loss. |
| | Deficiency results in poor wound healing, decreased mitochondrial |
| | energy production) and neurological defects. |
| Vitamin B2 | Required for oxidative energy production, electron transport system. |
| (Riboflavin) | Deficiency leads to altered skin and mucous membrane and nervous |
| | system function. |
| Vitamin B3 | Required for oxidative metabolism, and electron transport system. |
| (Niacin) | Refers to nicotinic acid and nicotinamide. |
| | Deficiency leads to irritability, diarrhea, and altered mitochondrial |
| | energy production. |
| Vitamin B6 | Required for gluconeogenesis and for glycogenolysis in which it |
| (Pyridoxine) | serves as a cofactor for glycogen phosphorylase. |
| | Acts as a cofactor for all transferases, transaminases, decarboxylases |
| | and cleavage enzymes used in transformations of amino acids. |
| | Also required for elastin and collagen cross linking. |
| | Deficiency leads to dermatitis, convulsions. |
| | Deficiency leads to poor growth, abnormal protein synthesis and |
| | amino acid metabolism, and homocystinuria. |
| Vitamin B9 | Serves as a coenzyme in single carbon transfers in the metabolism of |
| (Folic acid) | nucleic and amino acids. |
| | Required for synthesis of purines and pyrimidines that are needed for |
| | DNA production and erythropoiesis. |
| | Required for hemoglobin and nucleic acid formation. |
| | Deficiency causes abnormal cell replication, particularly in the |
| | erythropoeitic system and results in megaloblastic anemia. |
| Vitamin B12 | Functions as a coenzyme for the methyl transfer reaction that converts |
| (Cyanocobalamin) | homocysteine to methionine and another reaction that converts L- |
| | methyl-malonyl coenzyme A to succinyl coenzyme A. |
| | Also required for normal erythrocyte production and neurologic |
| | function. |
| | Required for hemoglobin formation. |
| | Deficiency leads to anemia, neurologic symptoms. |
| Vitamin B7 | Is involved in important metabolic pathways such as gluconeogenesis, |
| (Biotin) | fatty acid synthesis, and amino acid catabolism. |
| | Biotin regulates the catabolic enzyme propionyl-CoA carboxylase at |
| | the posttranscriptional level whereas the holo-carboxylase synthetase |
| | is regulated at the transcriptional level. |
| | Biotin functions as a cofactor that aids in the transfer of CO2 groups to |
| | various target macromolecules. |
| | Deficiency leads to metabolic problems including very low blood |
| | sugars between meals, high blood ammonia, or acidic blood (acidosis) |
| | can occur. |
| Vitamin B5 | Is a precursor of the coenzymes, CoA and acyl carrier protein of fatty |
| (Pantothenic acid) | acid synthase, which are involved in more than 100 different metabolic |
| | pathways including energy metabolism of carbohydrates, proteins and |
| | lipids, and the synthesis of lipids, neurotransmitters, steroid hormones, |
| | porphyrins and hemoglobin. |
| | Deficiency leads to depression, personality changes, cardiac |
| | instability, frequent infection, fatigue, abdominal pains, sleep |
| | disturbances and neurological disorders including numbness, |
| | paresthesia (abnormal sensation such as “burning feet” syndrome), |
| | muscle weakness and cramps. Biochemical changes include |
| | increased insulin sensitivity, lowered blood cholesterol, decreased |
| | serum potassium, and failure of adrenocorticotropin to induce |
| | eosinopenia. |

Minerals, like vitamins, are used for a wide variety of biological processes. Humans require about twenty minerals classified as either macrominerals or trace elements. In relation to individuals engaging in physical activity, minerals are important for their involvement in, inter alia, muscle contractions, nerve signaling, oxygen transport, oxidative phosphorylation and bone formation. Deficiencies in specific minerals have been linked to either decrease in athletic activity or as being caused by athletic activity. Such minerals include calcium, iron and zinc. Table 2 lists some common minerals and their roles.

TABLE 2
Common Minerals

| | |
|---|---|
| Calcium | Involved in muscle contractions: excitation-contraction coupling. |
| | Ca2+ signaling is believed to be involved in changes in CHO |
| | metabolism, gene transcription, protein synthesis and modulating ion |
| | homeostasis in skeletal muscle during exercise/contractions. |
| Iron | Required for hemoglobin synthesis. |
| | Required for the delivery of oxygen to tissues and the use of oxygen at |
| | the cellular and sub cellular levels. |
| | Plays critical role in energy use during work |
| | Deficiency leads to anemia, cognitive impairment, immune |
| | abnormalities. |
| | Deficiency without anemia leads to an increased reliance on glycolytic |
| | metabolism thus impairs work performance by promoting skeletal |
| | muscle fatigue. |
| Iodine | Required by humans for the synthesis of thyroid hormones which |
| | regulate metabolism. |
| | Chronic iodine deficiency can lead to numerous health problems in |
| | children and adults, including thyroid gland dysfunction (including |
| | goiter) and various neurologic, gastrointestinal, and skin abnormalities. |
| Magnesium | Involved in more than 300 enzymatic reactions in which food is |
| | metabolized and new products are formed. |
| | Involved in glycolysis, fat and protein metabolism, adenosine |
| | triphosphate hydrolysis and second messenger system. |
| | Serves as a physiologic regulator of membrane stability and |
| | neuromuscular, cardiovascular, immune and hormonal functions. |
| | May be considered a potentially limiting element for human |
| | performance. |
| | Required for energy metabolism, nerve conduction, muscle |
| | contraction. |
| | Deficiency leads to muscle weakness, nausea and irritability. |
| Zinc | Required for the structure and activity of more than 300 enzymes. |
| | Required for nucleic acid and protein synthesis, cellular differentiation |
| | and replication, glucose use and insulin secretion, and carbon dioxide |
| | removal. |
| | Exerts regulatory actions in various aspects of hormone metabolism |
| | including the production, storage and secretion of hormones and |
| | regulating interactions between hormones and receptors and end |
| | organ responsiveness. |
| | Needed for the integration of systems: immunity, reproduction, taste, |
| | wound healing, skeletal development, behavior and GI function. |
| | Zinc status regulates work performance. |
| | Required for cell differentiation and histone assembly and structure |
| | Deficiency leads to poor wound healing, poor growth, and skeletal and |
| | cranial anomalies in young animals. |
| | Deficiency leads to loss of appetite, growth, retardation, immune |
| | abnormalities. |
| Selenium | Functions as a redox center and is a component of at least 35 |
| | selenoproteins. |
| | Involved in cell growth, apoptosis and modifying the action of cell |
| | signaling systems and transcription factors. |
| | Deficiency can lead to muscle myopathy. |
| Copper | Required for collagen and elastin cross linking. |
| | Deficiency leads to skin friability, aneurysms, bone fragility, and loss of |
| | coat color and structural integrity. |
| Manganese | Is a cofactor for glycosyl transferases. |
| Chromium | Regulates glucose, lipid and protein metabolism by potentiating the |
| | action of insulin at the cellular level. |
| | Facilitates insulin action, resulting in decreased need for insulin. |
| | Deficiency leads to glucose intolerance. |
| Sodium and Potassium | Assists in rehydration by effecting osmolytic water balances. |
| | Shown to restore body fluid losses, which is necessary for optimal |
| | cardiovascular function and thermoregulation during subsequent |
| | exercise. |
| | Helps to maintain thirst and stimulate drinking. |

In a preferred embodiment of the present invention, a composition is provided containing creatine or derivatives of creatine, at least one insulin support substance and a vitamin-mineral mix. It is herein understood by the inventors that the activity of insulin will promote the uptake and retention, by muscle, or creatine. It is further understood that creatine, vitamins and minerals will support physical activity.

In another embodiment of the present invention, a composition is provided containing creatine or derivatives of creatine, at least one insulin support substance and a vitamin-mineral mix, wherein a portion of the creatine or derivative of creatine and the vitamin-mineral mix is fine-milled. It is herein understood that fine-milling of substances results in a smaller average particle size, which provides for increased solubility and bioavailability. The preferred portion of fine-milled substances is from about 1% to about 10% by weight of the substance.

In an additional embodiment of the present invention, the composition also contains at least one additional substance with anabolic activity. Non-limiting examples of such anabolic substances are choline, leucine, valine, isoleucine, lysine, threonine, carnitine, and extract of Agaricus bisporus. The preferred additional anabolic substance is leucine. It is herein understood that physical activity is largely dependent on muscle health and function.

In yet a further embodiment of the present invention, the composition also contains at least one additional substance with antioxidant activity. Non-limiting examples of such antioxidant substances are Vitamin A, Vitamin C, Vitamin E, selenium, alpha-lipoic acid, astaxanthin, coenzyme Q9, coenzyme Q10, lutein, N-acetyl cysteine, superoxide dismutase, idebenone, Polygonum cuspidatum; tomato extract, Ginkgo biloba, grape extract, ginger extract, apple extract, mulberry extract, blueberry extract, bilberry extract, blackberry extract, and acai berry extract. Preferably, the antioxidant substance is distinct from any substance already present as a vitamin or mineral representing the vitamin-mineral mix or already present as an insulin support substance. The preferred antioxidant substance is vitamin C. It is herein understood that antioxidants act to protect the integrity of cell membranes and cellular structures, particularly the components of energy production which are susceptible to free radical-induced damage.

According to various embodiments of the present invention, the nutritional supplement may be consumed in any form. For instance, the dosage form of the nutritional supplement may be provided as, e.g., a powder beverage mix, a liquid beverage, a ready-to-eat bar or drink product, a capsule, a liquid capsule, a tablet, a caplet, an effervescent tablet, or as a dietary gel. The preferred dosage form of the present invention is as a caplet.

Furthermore, the dosage form of the nutritional supplement is provided in accordance with customary processing techniques for herbal and nutritional supplements in any of the forms mentioned above. Additionally, the nutritional supplement set forth in the example embodiment herein disclosed may contain any appropriate number and type of excipients, as is well known in the art.

Although the following examples illustrate the practice of the present invention in five of its illustrative compositional embodiments, the examples should not be construed as limiting the scope of the invention. Other embodiments will be apparent to one of skill in the art from consideration of the specifications and examples.

### EXAMPLES

### Example 1

A nutritional supplemental composition is provided comprising the following ingredients per serving is prepared for consumption as a caplet to be consumed once daily, preferably with a meal:

About 2.5 g of Creatine monohydrate, about 0.1 g of Alpha-lipoic acid, about 0.08 g of Vitamin B1, and about 0.25 g of Calcium.

### Example 2

A nutritional supplemental composition is provided comprising the following ingredients per serving is prepared for consumption as 5 caplets to be consumed once daily, preferably with a meal:

About 2.5 g of Creatine monohydrate, about 0.015 g of Leucine, about 0.1 g of Alpha-lipoic acid, about 0.5 g of Vitamin C, about 0.08 g of Vitamin B3, and about 0.15 g of Magnesium.

### Example 3

A nutritional supplemental composition is provided as described in example 2; however 10% of the Creatine monohydrate, Alpha-lipoic acid, Vitamin B3 and Magnesium are fine-milled.

### Example 4

A nutritional supplemental composition is provided comprising the following ingredients per serving is prepared for consumption as 5 caplets to be consumed once daily, preferably with a meal:

About 2.5 g of Creatine monohydrate, about 0.01 g of L-Leucine, about 0.001 g L-Leucine isovalaric acid, about 0.001 g of L-Leucine ketoisocaproic acid, about 0.01 g of L-Taurine,

### Example 5

A nutritional supplemental composition is provided comprising the following ingredients per serving is prepared for consumption as 5 caplets to be consumed once daily, preferably with a meal:

About 2.5 g of Creatine monohydrate, about 0.1 g of Alpha-lipoic acid, about 700 IU Vitamin D, about 10,000 IU Vitamin A, about 0.08 g of Vitamin B1 about 0.08 g of Vitamin B3, about 0.025 g Zinc, and about 0.25 g of Calcium.

### Extensions and Alternatives

In the foregoing specification, the invention has been described with specific embodiments thereof; however, it will be evident that various modifications and changes may be made thereto without departing from the broader spirit and scope of the invention.

All publications which are cited herein are hereby specifically incorporated by reference into the disclosure for the teachings for which they are cited.

1. A composition comprising creatine or derivatives of creatine, at least one insulin support substance and a vitamin-mineral mix.

2. The composition of claim 1, wherein the insulin support substance is selected from the group consisting of:
alpha-lipoic acid, ketoisocaproate, D-pinitol, Protogen A, taurine, and respective derivatives thereof.

3. The composition of claim 2, wherein from about 1% by weight to about 10% by weight of the creatine or derivatives of creatine and the vitamin-mineral mix is fine-milled.

4. The composition of claim 3, wherein the vitamin-mineral mix comprises at least one dietary vitamin and at least one dietary mineral.

5. The composition of claim 4, wherein the dietary vitamin is selected from the group consisting of:
Vitamin A, Vitamin C, Vitamin D, Vitamin E, Vitamin K, Vitamin K2, Vitamin B1, Vitamin B2, Vitamin B3, Vitamin B5, Vitamin B6, Vitamin B7, Vitamin B9, Vitamin B12, and respective derivatives thereof;
and the dietary mineral is selected from the group consisting of:
calcium, iron, iodine, magnesium, selenium, zinc, copper, manganese, chromium, sodium, potassium, gold, silver, and respective derivatives thereof.

6. The composition of claim 5, further comprising an anabolic substance selected from the group consisting of:
choline, leucine, valine, isoleucine, lysine, threonine, carnitine, respective derivatives thereof, and an extract of Agaricus bisporus.

7. The composition of claim 5, further comprising an antioxidant substance.

8. The composition of claim 7, wherein the antioxidant substance selected from the group consisting of:
Vitamin A, Vitamin C, Vitamin E, selenium, alpha-lipoic acid, astaxanthin, coenzyme Q9, coenzyme Q10, lutein, N-acetyl cysteine, superoxide dismutase, idebenone, Polygonum cuspidatum; tomato extract, Ginkgo biloba, grape extract, ginger extract, apple extract, mulberry extract, blueberry extract, bilberry extract, blackberry extract, and acai berry extract;
wherein said antioxidant substance is different than the components of the vitamin-mineral mix and the insulin support substance.

9. A composition comprising:
creatine,
leucine
alpha-lipoic acid
Vitamin C,
Vitamin B3, and
magnesium.

10. A method of supporting cellular energetics in an individual comprising providing to said individual a composition comprising creatine or derivatives of creatine, at least one insulin support substance and a vitamin-mineral mix.

11. The method of claim 10, wherein the insulin support substance is selected from the group consisting of:
alpha-lipoic acid, ketoisocaproate, D-pinitol, Protogen A, taurine, and respective derivatives thereof.

12. The method of claim 11, wherein from about 1% by weight to about 10% by weight of the creatine or derivatives of creatine and the vitamin-mineral mix is fine-milled.

13. The method of claim 12, wherein the vitamin-mineral mix comprises at least one dietary vitamin and at least one dietary mineral.

14. The method of claim 13, wherein the dietary vitamin is selected from the group consisting of:
Vitamin A, Vitamin C, Vitamin D, Vitamin E, Vitamin K, Vitamin K2, Vitamin B1, Vitamin B2, Vitamin B3, Vitamin B5, Vitamin B6, Vitamin B7, Vitamin B9, Vitamin B12, and respective derivatives thereof;
and the dietary mineral is selected from the group consisting of:
calcium, iron, iodine, magnesium, selenium, zinc, copper, manganese, chromium, sodium, potassium, gold, silver, and respective derivatives thereof.

15. The method of claim 14, wherein the composition further comprises an anabolic substance selected from the group consisting of:
choline, leucine, valine, isoleucine, lysine, threonine, carnitine, respective derivatives thereof, and an extract of Agaricus bisporus.

16. The composition of claim 14, further comprising an antioxidant substance.

17. The composition of claim 16, wherein the antioxidant substance selected from the group consisting of:
Vitamin A, Vitamin C, Vitamin E, selenium, alpha-lipoic acid, astaxanthin, coenzyme Q9, coenzyme Q10, lutein, N-acetyl cysteine, superoxide dismutase, idebenone, Polygonum cuspidatum; tomato extract, Ginkgo biloba, grape extract, ginger extract, apple extract, mulberry extract, blueberry extract, bilberry extract, blackberry extract, and acai berry extract.
wherein said antioxidant substance is different than the components of the vitamin-mineral mix and the insulin support substance.
